(19) United States
(12) Patent Application Publication
(10) Pub. No.: US 2026/0135814 A1
(43) Pub. Date: May 14, 2026

(54) MONITORING CONGESTION FOR HIGH LATENCY DATA CENTERS

(71) Applicant: Meta Platforms, Inc., Menlo Park, CA (US)

(72) Inventors: Pankaj Kansal, Fremont, CA (US); Arvind Srinivasan, San Jose, CA (US); Ved Kushwaha, Cupertino, CA (US); Harikrishna Madadi Reddy, San Jose, CA (US); Zeeshan Altaf Lokhandwala, Redwood City, CA (US)

(21) Appl. No.: 18/948,313

(22) Filed: Nov. 14, 2024

(51) Int. Cl. H04L 47/283; H04L 43/0864

(52) U.S. Cl. CPC H04L 47/283; H04L 43/0864

(57) ABSTRACT

Various systems, methods, and devices are described for a data center system configured to assign queue pairs (QPs) to one or more nodes based on a received round trip time. In an example, systems and methods of assigning QPs may include assigning QPs to one or more nodes. If a round trip time (RTT) is determined to be above a threshold two or more QPs may be assigned to that node. Each node associated with the data center system may be assigned a QP. The nodes associated with a RTT below the threshold may only receive one QP. In some examples, the threshold may be the average RTT of the data center system. However, it is contemplated that the threshold may be any suitable value for the data center system. The RTT may be monitored periodically or continuously such that QPs may be altered with changes in RTT over time.

### TECHNOLOGICAL FIELD

The present disclosure generally relates to methods, apparatuses, and computer program products for network monitoring, specifically to reducing latency associated with data transferred via data centers.

### BACKGROUND

Large-scale data centers are the backbone of modern computing, supporting a vast array of applications and services that drive global communication, commerce, and innovation. These massive facilities are used by tech giants, cloud providers, enterprises, or the like to store, process, and distribute enormous amounts of data, enabling cloud computing, social media, e-commerce, online search, and big data analytics.

As data center technology is rapidly evolving, with advancements in areas such as artificial intelligence, machine learning, and the Internet of Things (IoT) driving demand for more powerful, efficient, and sustainable data centers. In some examples, data centers may experience delays in data transfer due to a combination of increased number of data packets being transferred and longer cable lengths. As a result, as the influx of data increases there may be an increase in round trip time (RTT) associated with the transmission of data.

As such, there may be a need for more efficient and effective techniques (e.g., approaches) that may reduce RTT associated with data transfer in data centers.

### BRIEF SUMMARY

Various systems, methods, and devices are described for reducing latency in large scale data centers via assigning queue pairs (QPs).

The exemplary aspects of the present disclosure may provide a method to assigning QPs to the transfer of data between one or more nodes associated with a data center. Each node of the number of nodes may be assigned one or more QP based on a round-trip time (RTT) associated with the transfer of data between one or more nodes. Each of the one or more QPs may comprise a nominal block of transfer resources (e.g., as referred to herein as transfer resources) and a connection between one or more nodes that define a data transfer path (e.g., data transfer from a first node to a second node).

In various examples, systems, methods, and devices of the present disclosure may assign QPs associated with data transfer between nodes of a data center. One or more RTT may be received via a load balancing mechanism associated with a hub device. Based on the received one or more RTT associated with the transfer of data from one node to another node of the number of nodes one or more QPs may be assigned. two or more QPs may be assigned to a second node of the number of nodes based on one of the one or more RTT being above a threshold. In some examples, the threshold may be an average of the one or more RTT received in the system. Each of the QPs comprise a data transfer path (e.g., from one node to another node) and a nominal block of transfer resources (e.g., transfer resources). Nodes with a RTT above the threshold may have two or more QPs associated with that node (e.g., the second node). The one or more RTT of the system may be monitored periodically based on the speed of data transfer such that the QPs may be assigned variably based on the influx of data at a node.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1A illustrates a traditional data center in accordance with an example of the present disclosure.

FIG. 1B illustrates a traditional data center in accordance with an example of the present disclosure.

FIG. 2 illustrates an example data center in accordance with an example of the present disclosure.

FIG. 3 illustrates an example method in accordance with an example of the present disclosure.

FIG. 4 illustrates an example system in accordance with an example of the present disclosure.

FIG. 5 illustrates an example computing device in accordance with an example of the present disclosure.

FIG. 6 is a diagram of an exemplary computing system in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

Large-scale data centers are the backbone of modern computing, supporting a vast array of applications and services that drive global communication, commerce, and innovation. These massive facilities are used by tech giants, cloud providers, enterprises, or the like to store, process, and distribute enormous amounts of data, enabling cloud computing, social media, e-commerce, online search, and big data analytics.

As data center technology is rapidly evolving, with advancements in areas such as artificial intelligence, machine learning, and the Internet of Things (IoT) driving demand for more powerful, efficient, and sustainable data centers. In some examples, data centers may experience delays in data transfer due to a combination of increased number of data packets being transferred and longer cable lengths. As a result, as the influx of data increases there may be an increase in round trip time (RTT) associated with the transmission of data.

Delays in large-scale data centers can occur when there is an increase in round-trip time (RTT), which is the time it takes for a data packet to travel from the sender to the receiver and back. As data centers grow in size and complexity, the distance between servers and switches increases, leading to longer cable lengths and higher latency. This increased RTT can cause delays in data transmission, processing, and storage, ultimately affecting the overall performance of the data center. For example, in a distributed database, an increase in RTT can slow down data replication and synchronization, leading to delays in data availability and consistency. Similarly, in cloud computing environments, higher RTT can result in slower response times for user requests, impacting application performance and user experience. Furthermore, increased RTT can also amplify the effects of network congestion, packet loss, and errors, making it challenging to maintain high availability and reliability in large-scale data centers.

These drawbacks may be more apparent in AI training clusters, as the size of the workloads and data are growing exponentially as technology advances. Conversely, machine learning model complexity and thread are also growing that require large training clusters of AI training accelerators, where the accelerators may communicate with each other to facilitate the exchange of training data/results. For example, AI training clusters may be built using high performance accelerators communicating with each other via a high throughput/low latency back-end network. This communication among accelerators may be performed using state of the art remote direct memory access (RDMA) transport protocols to support go-back-N or selective acknowledgement based retransmission schemes to reduce tail latency. There are examples in which selective acknowledgement mechanisms may bring an added advantage of reducing tail latency by re-transmitting only the individual packets lost in the network. However, selective acknowledgement based schemes may incur higher cost than when there is a need to support a limited number of inflight outstanding data packets. This may result in a larger number of outstanding requests among the nodes to absorb RTT. To combat the larger number of outstanding requests, larger accelerators may be utilized, where the cost and power of the accelerator and supporting hardware may increase with the increase of accelerator size. Additionally, with the with increase in accelerator size in combination with larger data centers, many AI training clusters may require longer cable lengths. As such, with longer cable lengths the transfer of data packets may incur a high latency leading to increased RTT between one or more nodes of a data center.

As such, there may be a need for more efficient, flexible, or cost-effective techniques (e.g., approaches or solutions) using traditional software or hardware components without making changes to the network interface card (NIC) data path, that may reduce latency in AI training clusters. The NIC data path may refer to the hardware components or pathways within a data center's NIC that process and transmit data packets. The data path may be responsible for receiving incoming data from the network, storing it in buffers, and then forwarding it to the host server's CPU for processing. Conversely, the data path may also handle outgoing data from the server, buffering and transmitting it to the network. The NIC data path may consists of several key components, including the media access controller (MAC), the physical layer (PHY) transceiver, or the direct memory access (DMA) engine. The MAC may manage data transmission and reception, while the PHY transceiver may handle physical layer functions, such as signal processing and transmission. The DMA engine may enable direct data transfer between the NIC and server memory, reducing CPU overhead. By optimizing the NIC data path, data centers may improve network throughput, reduce latency, or increase overall system efficiency, ultimately supporting faster or more reliable data processing or transmission. As such, the present disclosure discloses a hardware-based load balancing approach utilizing one or more QPs between the nodes having a longer RTT.

In an example, a load balancing approach may ensure efficient distribution of network traffic (e.g., data packets) across multiple servers, storage devices, nodes, or other resources. Load balancing may help prevent any single resource from becoming overwhelmed and becoming a bottleneck, thereby improving overall system performance, reliability, or scalability. Load balancing hardware, such as application delivery controllers (ADCs) or load balancers, may sit between the network and the servers, directing incoming requests to available resources based on predefined algorithms and policies. This may ensure that no single server is overloaded, which may reduce the risk of downtime or improve response times. Load balancing may also be configured to allow data centers to add or remove resources as needed, without disrupting services, which may make load balancing a significant feature for cloud computing, e-commerce, or other high-traffic applications. By distributing workloads effectively, load balancing may help data centers to optimize resource utilization, increase throughput, or provide a better user experience.

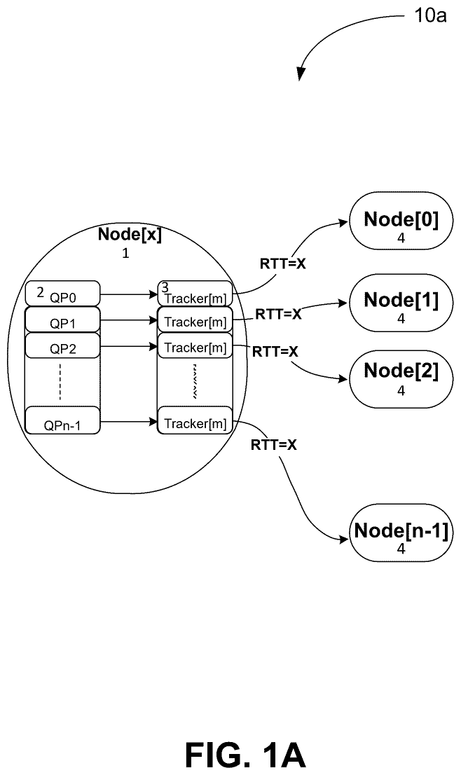

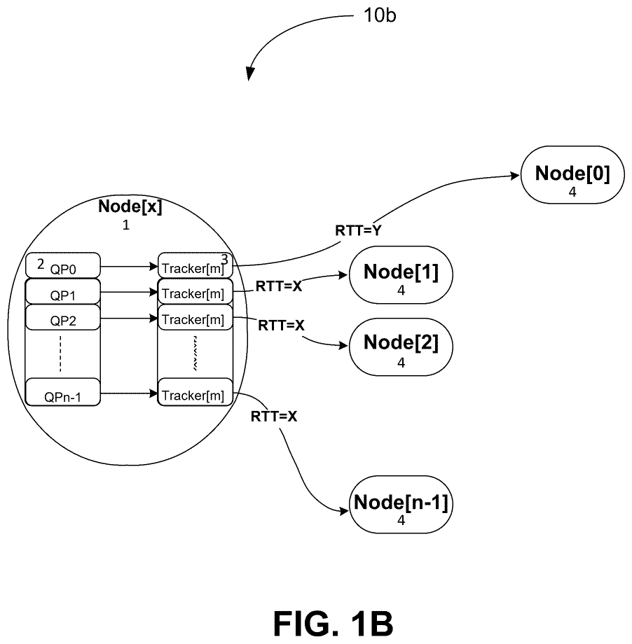

FIG. 1A and FIG. 1B may illustrate example traditional data canter 10a,b. In FIG. 1A, the traditional data center 10a may comprise a node 1 (e.g., node[x]), and one or more other nodes 4 (e.g., node [0], node[1], node[2], and node[n-1]). The node 1 may comprise one or more QPs 2 (e.g., QP0, QP1, QP2, and QPn-1), and one or more trackers resources 3 (e.g., tracker[m]). Trackers are further described herein. To further clarify the role of trackers, trackers may be associated with a hardware component (or software component) that keeps track of outstanding packets. Trackers may be considered resources assigned per QP. For RTT, the following example provides insight: A 1000 entry may be assigned for a tracker where each entry represents one packet time. The 1000 entries behave like a window in which when 1000 packets are sent on the wire, there is a waiting period for acknowledgments (acks) before sending the 1001st packet. This represents that if the RTT is <=1000 packet time, the network throughput and wire can remain busy. On the other hand, if the RTT is 2×(1000 packet times), then there will be 1000 packet time worth of dead time while waiting for acks to show up. Effectively, this means the effective bandwidth utilization will be 50% only. This also means that the message completion time may be 2× the ideal value. In this example, in order to recover the lost time, 2000 tracker entries may be needed to achieve the ideal time.

One of the one or more tracker resources 3 may comprise an identical number of resources or components for one of the one or more nodes to function in a manner suitable to the data center 10a. In the example of FIG. 1A, the data center 10a may operate at an average RTT (e.g., RTT=X) or latency among the one or more nodes 4 in the data center 10a. As such, due to the hardware of the AI training cluster operating at an average latency between the nodes (e.g., data path between node 1 and one of the one or more nodes 4), a node(s)s that may include more data packets or require more data transfer may experience increased latency or lost outstanding data packets.

In FIG. 1B, the traditional data center 10b may include components similar to FIG. 1A such as but not limited to, node 1, one or more other nodes 4, one or more QPs 2, or one or more tracker resources 3. In the example of FIG. 1B, the data center 10b may be configured to allow higher latency tolerance for data transfer as illustrated with RTT=Y of node[0]. The higher latency tolerance for some QPs may be utilized to absorb high RTT, however the increased or higher latency tolerance may limit the number of communication channels between the nodes with higher RTT, meaning that there will be an increase in lost or increased latency associated with data transfer toward or from node [0] as RTT=Y illustrates an increased latency. As such, the data transmission for node[0] may be greatly affected by the high latency leading to a decreased experience at node[0] in comparison to one or more other nodes (e.g., node[1], node[2], or node[n-1]).

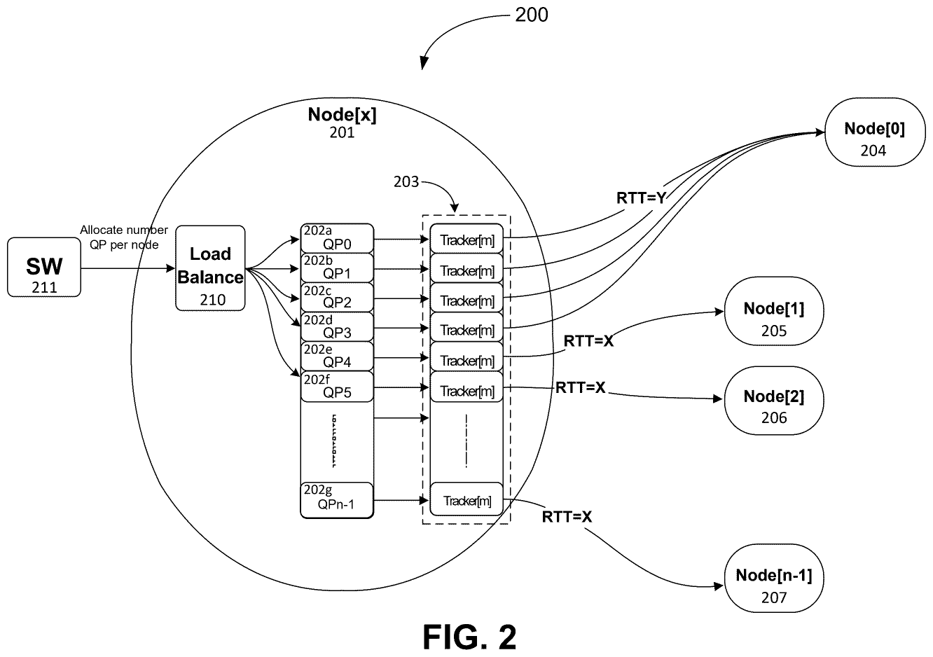

The nodes and trackers as illustrated in FIG. 1A, FIG. 1B, and FIG. 2 may be components for data center frameworks. Nodes and trackers (e.g., nominal blocks of tracker resources) may work together to manage or monitor a data center's resources or infrastructure. Trackers may be software or hardware components that monitor and track the state of performance of various data center resources, such as servers, storage, or network devices. In some examples, trackers may collect data on metrics like temperature, power consumption, or utilization rates, providing real-time insights into the data center's operational status. Nodes, however, may refer to the physical or virtual devices that make up the data center infrastructure, such as servers, switches, or storage arrays. Each node may be associated with a tracker that monitors its performance and reports back to the data center management system. The trackers and nodes may work together to enable data center managers to optimize resource allocation, predict or prevent failures, or help with efficient operation of the data center. By leveraging trackers and nodes, data centers may improve uptime, reduce costs, and increase overall efficiency, ultimately supporting the delivery of high-quality services and applications.

FIG. 2 may illustrate an example data center 200 in accordance with an example of the present disclosure. Data center 200 may comprise a first node 201 (e.g., node[x]), also referred to herein as a data center hub, e.g., main device associated with the data center 200 and may be operatively connected with one or more nodes (e.g., node 204, 205, 206, 207) of data center 200. Data center 200 may further comprise one or more nodes (e.g., a second node 204 (node[0]), a third node 205 (node[1]), a fourth node 206 (node[2]), or a fifth node 207 (node[n-1])). The first node 201 may comprise a load balance module 210, software (e.g., SW) 211, one or more QPs 202a,b,c,d,e,f,g, and one or more nominal block tracker resource(s) 203 (e.g., one or more tracker resource(s) 203 (tracker[n]). It is contemplated that SW 211 or load balance module 210 may be a component of the first node 201, located on a server, or another device not depicted in FIG. 2. As illustrated, the RTT for the second node 204 may be different (e.g., RTT=Y) than the RTT of the third node 205, the fourth node 206, or the fifth node 207 (e.g., RTT=X). In some examples, RTT of the third node 205, fourth node 206, and fifth node 207 may be an average RTT associated with the total RTT of the data center 200. In the illustration, it is contemplated that the RTT associated with the second node 204 is above a threshold, such as four times greater than the RTT of the other nodes (e.g., third node 205, fourth node 206, or fifth node 207), this may be illustrated by the number of QPs 202 associated with the second node 204. The threshold may be any suitable value associated with RTT, for example the threshold may be the average RTT for the system (e.g., data center 200). It is contemplated that the threshold may be variable depending on a total RTT of the data center, where in such examples the load balance module 210 may be configured to monitor and adjust the threshold based on the one or more received RTTs. The RTT of each QP (e.g., QPs 202a,b,c,d as illustrated in FIG. 2) associated with the second node 204 may have the same rate of time to return data back to a source or database (e.g., RTT may be the same for each QP associated with the second node 204). Assigning four QPs to the second node 204 may reduce the message transfer latency. Changes by assigning more QPs (and thereby more trackers) may reduce the message transfer latency. The message is striped across QPs by the load balancing block and utilizes some or all the trackers. For clarity, the message completion time may be measured at the message level, while individual data packet latency remains the same (e.g., constant).

One or more QPs (e.g., 202a,b,c,d) associated with a node (e.g., second node 204, third node 205, fourth node 206, or fifth node 207) may shorten the completion time of data transfer (e.g., transmission of data packets). Completion time may be shortened due to the resources available to the node compared to traditional systems. For example, it may take 10 seconds to complete transmission of message with a node and QP pair, however, with the addition of a second QP as disclosed the completion time to transmit the message may shortened to 5 seconds.

Similar to FIG. 1A and FIG. 1B, one or more tracker resources 203 may be any suitable resources necessary configured to aid in the transfer of data in the data center 200, wherein one or more tracker resource(s) 203 may be identical for one or more of the one or more tracker resource(s) 203. The load balance 210, may be configured to monitor (e.g., receive or assess) the one or more RTT associated with one or more nodes of data center 200 periodically, continuously, or any other suitable increment of time. In some examples, the QPs 202 may be assigned by the load balance mechanism 210. In some examples, due to the monitoring of the one or more RTTs associated with the data path between one or more nodes (e.g., data path from the first node 201 to the second node 204, third node 205, fourth node 206, or fifth node 207), the data center may be scalable as the QPs 202 may be adjusted based on the one or more RTTs received at any given time, for example, one or more nodes may have a RTT above the threshold. As such, it is contemplated that the load balance module 210 may determine the number of QPs 202 for each node of the number of nodes above the threshold. In some examples, messages or data packets may be introduced to the one or more nodes via SW 211, wherein the load balancing module 210 may be configured to spray messages or data packets between the one or more QPs 202. The load balancing module 210 may transmit the messages or data packets to each QP 202 in sequential order, in an interweaving manner (e.g., sending data packets or messages at random between QPs 202), or the like. Sending messages or packets in this manner may allow for the QPs 202 to be used efficiently due to each QP (e.g., one of the one or more QPs 202a, 202b, 202c, 202d, 202e, 202f, or 202g) having a separate network path between nodes. In an example, the hardware of the system (e.g., components of the one or more nodes) may be configured to reassemble received data packets to form a message or any other suitable information from the data packets received from one or more QPs. For example, a message may be transferred from a node (e.g., first node 201) to another node (e.g., second node 204), as a result one or more data packets may be spread among one or more QPs, via load balancing module 210. The data packets may include tracking or any other suitable methodology to maintain order of the received data packets such that the second node 204 may construct or recombine the received data packets to create the message that was sent.

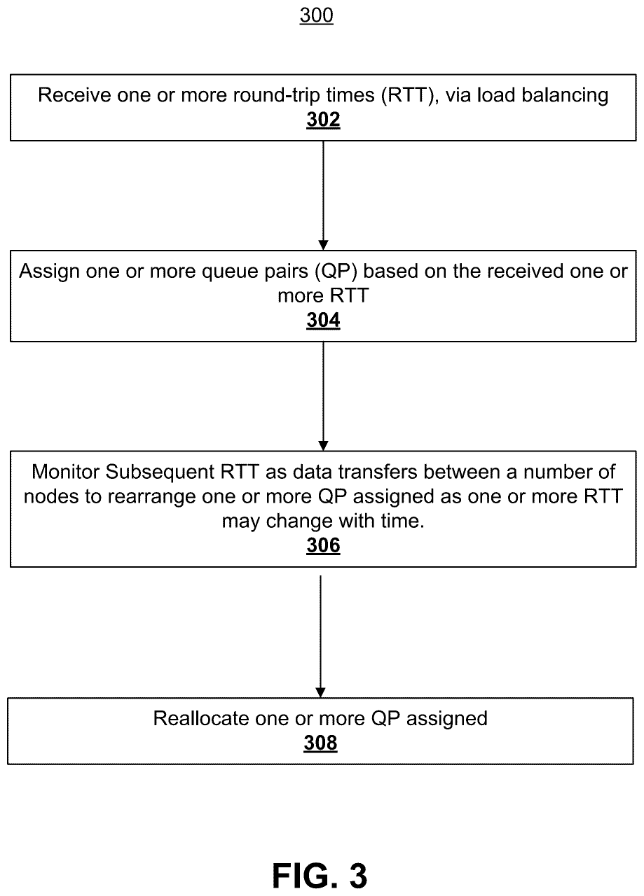

FIG. 3 illustrates an example method 300 for assigning and load balancing QPs based on RTT as disclosed herein. At step 302, one or more RTTs associated with one or more nodes may be received via load balancing hardware. In some examples, each node of the one or more nodes may be a different device, where the first node may be referred to as a hub device associated with a data center or a AI cluster trainer. In some examples, the first may be communicatively connected to one or more other nodes of the number of nodes (e.g., via wired connection or network 105). At step 304, one or more queue pairs (QP) may be assigned based on the received RTTs. One of the one or more QPs may comprise a nominal block of transfer resources, the first node, and another node. One or more QPs may be assigned to a second node of a number of nodes based on one of the RTTs being above a threshold. In some examples, one QP may be assigned to one or more nodes with RTTs below the threshold. Each QP assigned to the second node may comprise a nominal block of transfer resources (e.g., transfer resources) associated with data transfer between a first node and a second node. In some examples, the threshold may be the average of the nominal block of transfer resources for each of the one or more RTTs received. For example, if the transfer block is indicated as 10 milliseconds and the RTT to the second node is 40 seconds, there may be four QPs assigned and determined to be associated to the second node. At step 306, RTTs may be monitored associated with data transfers between nodes. At step 308, rearrange (e.g., change positioning or reallocate) QPs based on a threshold change of RTTs over time.

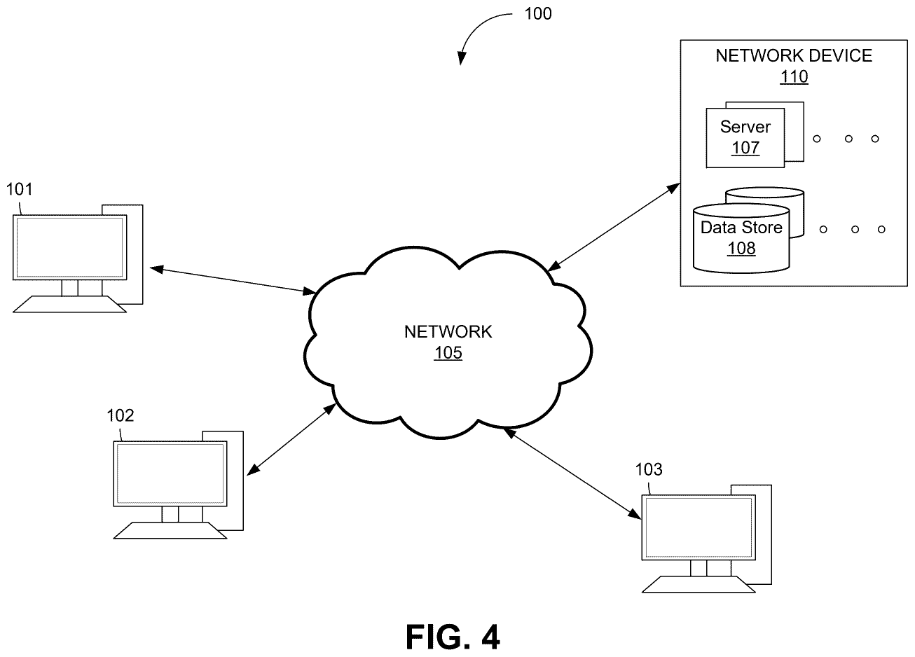

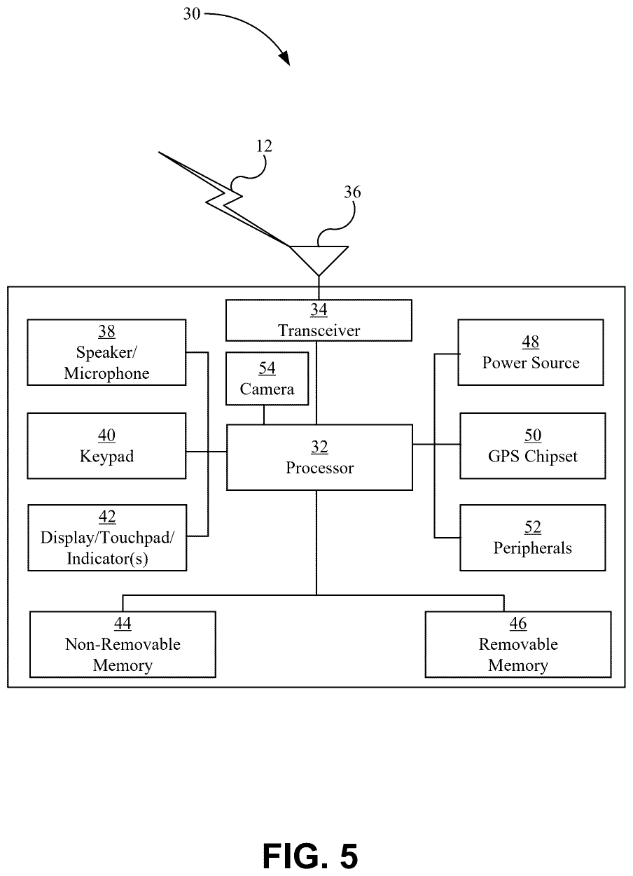

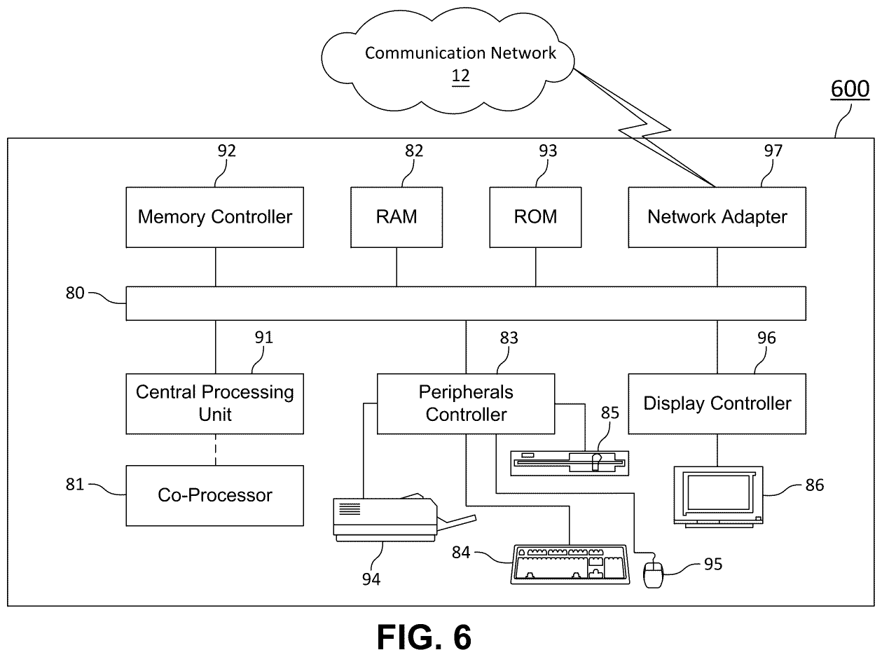

FIG. 4 illustrates an example system 100 according to example aspects of the present disclosure. The system 100 may be capable of facilitating the transmission of data among users, servers, databases, or any combination thereof. The system 100 may include one or more devices 101, 102, 103 (also may be referred to herein as user devices 101, 102, 103), server 107, data store 108, or network device 110. In some examples, devices 101, 102, and 103 may be examples of user equipment (UE) (e.g., UE 30 of FIG. 5). As shown for simplicity, network device 110 may comprise one or more servers (e.g., server 107) and one or more data stores (e.g., data store 108). In some examples, the network device 110 may be a computer system (e.g., computer system 600 of FIG. 6) capable of delivering internet based content or other content to users over a network 105 (e.g., the internet) via a web browser. In some examples, it is contemplated that the network device 110 may be a standalone device. In other examples, the network device may be located on a server. It is contemplated that network device 110 may interact and/or communicate with one or more devices (e.g., devices 101, 102, 103) of system 100.

In some examples, device 101, device 102 and device 103 may be associated with an individual (e.g., a user), entity (e.g., organization), node (e.g., accelerometer), or the like that may interact or communicate with data server(s) associated with network device 110. The network device 110 may be considered, or associated with, an application(s), a messaging platform(s), a social media platform(s), a website(s), or the like. In some examples, one or more users may use one or more devices (e.g., device 101, device 102, device 103) to access, send data to, and/or receive data from network device 110. In some examples, one or more entities may use one or more devices (e.g., device 101, device 102, device 103) to access, send data to, and/or receive data from network device 110.

This disclosure contemplates any suitable network 105. As an example and not by way of limitation, one or more portions of network 105 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 105 may include one or more networks 105. In particular examples, one or more network 105 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links.

The devices 101, 102 and 103 may be an electronic device including hardware, software, or embedded logic components or a combination of two or more such components and capable of carrying out the appropriate functionalities implemented or supported by the devices 101, 102, 103. As an example and not by way of limitation, devices 101, 102, 103 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 101, 102, 103). One or more of the devices 101, 102, 103 may enable a user to access network 105. One or more of the devices 101, 102, 103 may enable a user(s) to communicate with other users at other devices 101, 102, 103.

In particular examples, system 100 may include one or more servers 107. Each of the servers 107 may be a unitary server or a distributed server spanning multiple computers or multiple datacenters. Servers 107 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 107 may include hardware, software, or embedded logic components or a combination of two or more such components for carrying out the appropriate functionalities implemented or supported by server 107.

In particular examples, system 100 may include one or more data stores 108. Data stores 108 may be used to store various types of information. In particular examples, the information stored in data stores 108 may be organized according to specific data structures. In particular examples, each of the data stores 108 may be a relational, columnar, correlation, or other suitable database. Although this disclosure describes or illustrates particular types of databases, this disclosure contemplates any suitable types of databases. Particular examples may provide interfaces that enable devices 101, 102, 103 or another system (e.g., a third-party system) to manage, retrieve, modify, add, or delete, the information stored in data store 108.

In some examples, network device 110 may be a network-addressable computing system that may host an online search network. The network device 110 may store, receive, process, or analyze data. In examples, network device 110 may facilitate data interactions between clients (e.g., users), databases, and entities (e.g., organizations). In an example, the network device 110 may retrieve data from data bases (e.g., data store 108) and execute data mining processes or methods to extract information associated with the data. The network device 110 may be configured to handle a vast volume of data generated from a number of sources such as but not limited to web pages, social media platforms, or the like. The network device 110 may be configured to retrieve, process, or analyze data based on a request, where in response the network device 110 may retrieve relevant data from databases (e.g., data store 108), servers (e.g., server 107), or any other device of system 100. In some examples, network device 110 may be configured to perform methods or processes associated with data mining to generate a result associated with the request received.

Although FIG. 4 illustrates a particular arrangement of device 101, device 102, device 103, network 105, server 107, data store 108, and/or network device 110, among other things, this disclosure contemplates any suitable arrangement. The devices of system 100 may be physically or logically co-located with each other in whole or in part.
It should be pointed out that although FIG. 4 shows one network device 110, server 107, data store 108 and three devices 101, 102, and 103, any suitable number of network devices 110, devices 101, 102, 103, servers 107, and data stores 108 may be part of the system 100 of FIG. 4 without departing from the spirit and scope of the present disclosure.

FIG. 5 illustrates a block diagram of an example hardware/software architecture of user equipment (UE) 30. As shown in FIG. 5, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 6 is a block diagram of an exemplary computing system 500. In some exemplary embodiments, the network device 110 may be a computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 12 of FIG. 5, to enable the computing system 500 to communicate with other nodes (e.g., UE 30) of the network.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

Methods, systems, or apparatus with regard to load balancing based on round-trip times (RTT) are disclosed herein. A method, system, or apparatus may provide for receiving one or more round-trip times (RTT) via a load balance module; assigning one or more queue pairs (QP) based on the received RTT, wherein one or more QP are assigned to a second node of a number of nodes based on one of the RTT above a threshold, one QP is assigned to other nodes of the number of nodes below the threshold, and each of the QP assigned to the second node comprises a nominal block of transfer resources associated with data transfer between a first node and a second node; and monitoring RTT as data transfers between a number of nodes to rearrange QP assigned as RTT may change with time. One of the QP may comprise a nominal block of transfer resources, the first node of the number of nodes, and another node of the number of nodes. RTT below the threshold may be associated with one QP. Each of the number of nodes may be different devices. The first node may be a hub device associated with a data center, communicatively connected to each of the number of nodes. The threshold may be the average of the RTT. An RTT associated with one of the one or more other nodes may have been detected to have increased above the threshold and response to the detection, an additional QP may be assigned to the one of the one or more other nodes. There may be tracking (e.g., monitoring) of RTTs during data transfers between nodes to adaptively reallocate QPs as RTTs vary over time and an indication thereof. All combinations (including the removal or addition of steps) in this paragraph are contemplated in a manner that is consistent with the other portions of the detailed description.

What is claimed:

1. A method comprising:
receiving one or more round-trip times (RTTs) via a load balance module;
assigning one or more queue pairs (QPs) based on the received one or more RTTs, wherein:
one or more QPs are assigned to a second node of a plurality of nodes based on a first RTT of the one or more RTTs above a threshold;
a first QP is assigned to other nodes of the plurality of nodes below the threshold; and
the one or more QPs assigned to the second node comprises a nominal block of transfer resources associated with data transfer between a first node and the second node; and
monitoring one or more subsequent RTTs; and
providing instructions to reallocate the one or more QPs assigned based on a threshold change of the one or more subsequent RTTs over time.

2. The method of claim 1, wherein the one or more QPs comprises a nominal block of transfer resources, the first node of the plurality of nodes, and another node of the plurality of nodes.

3. The method of claim 1, wherein the first RTT of the one or more RTTs below the threshold define are associated with one QP.

4. The method of claim 1, wherein the plurality of nodes are different devices.

5. The method of claim 1, wherein the first node is a hub device associated with a data center, wherein the first node is communicatively connected to the plurality of nodes.

6. The method of claim 1, wherein the threshold is the average of the one or more RTTs.

7. The method of claim 1, further comprising:
detecting that a second RTT associated with the first node has decreased below the threshold; and
removing, based on the detecting, one or more QPs from the first node.

8. A device comprising:
one or more processors configured to:
receive one or more round-trip times (RTTs) via a load balance module;
assign one or more queue pairs (QPs) based on the received one or more RTTs, wherein:
one or more QPs are assigned to a second node of a plurality of nodes based on a first RTT of the one or more RTTs above a threshold;
a first QP is assigned to other nodes of the plurality of nodes below the threshold; and
the one or more QPs assigned to the second node comprises a nominal block of transfer resources associated with data transfer between a first node and the second node; and
monitor one or more subsequent RTTs; and
provide instructions to reallocate the one or more QPs assigned based on a threshold change of the one or more subsequent RTTs over time.

9. The device of claim 8, wherein the one or more QPs comprises a nominal block of transfer resources, the first node of the plurality of nodes, and another node of the plurality of nodes.

10. The device of claim 8, wherein the first RTT of the one or more RTTs below the threshold define are associated with one QP.

11. The device of claim 8, wherein the plurality of nodes are different devices.

12. The device of claim 8, wherein the first node is a hub device associated with a data center, the first node is communicatively connected to the plurality of nodes.

13. The device of claim 8, wherein the threshold is the average of the one or more RTTs.

14. The device of claim 8, wherein the one or more processors are further configured to:
detect that a second RTT associated with the first node has decreased below the threshold; and
remove, based on the detecting, one or more QPs from the first node.

15. A non-transitory computer-readable medium storing instructions when executed by one or more processors of a device, cause the device to:
receive one or more round-trip times (RTTs) via a load balance module;
assign one or more queue pairs (QPs) based on the received one or more RTTs, wherein:
one or more QPs are assigned to a second node of a plurality of nodes based on a first RTT of the one or more RTTs above a threshold;
a first QP is assigned to other nodes of the plurality of nodes below the threshold; and
the one or more QPs assigned to the second node comprises a nominal block of transfer resources associated with data transfer between a first node and the second node; and
monitor one or more subsequent RTTs; and
provide instructions to reallocate the one or more QPs assigned based on a threshold change of the one or more subsequent RTTs over time.

16. The non-transitory computer-readable medium of claim 15, wherein the one or more QPs comprises a nominal block of transfer resources, the first node of the plurality of nodes, and another node of the plurality of nodes.

17. The non-transitory computer-readable medium of claim 15, wherein the first RTT of the one or more RTTs below the threshold define are associated with one QP.

18. The non-transitory computer-readable medium of claim 15, wherein the plurality of nodes are different devices.

19. The non-transitory computer-readable medium of claim 15, wherein the first node is a hub device associated with a data center, the first node is communicatively connected to the plurality of nodes.

20. The non-transitory computer-readable medium of claim 15, wherein the threshold is the average of the one or more RTTs.
